(19) United States
(12) Patent Application Publication
(10) Pub. No.: US 2019/0340350 A1
(43) Pub. Date: Nov. 7, 2019

(54) VERIFICATION SYSTEM

(71) Applicant: KOLUMBO HOLDINGS LIMITED, Hong Kong (HK)

(72) Inventor: Aaron Raymond Campbell, Manly (AU)

(21) Appl. No.: 15/969,689

(22) Filed: May 2, 2018

(51) Int. Cl. G06F 21/42; G06F 21/32; G06F 21/62

(52) U.S. Cl. CPC G06F 21/42; G06F 21/6245; G06F 21/32

(57) ABSTRACT

A method includes receiving biometric information. The method further includes generating a hash associated with the biometric information. The method further includes sending the biometric information to a first computing device. The method further includes sending the hash to a second computing device. The method further includes receiving verification of the biometric information based on sending the biometric information to the first computing device. The method includes synchronizing an electronic application, stored by the device, with the second computing device based on receiving the verification of the biometric information.

### BACKGROUND

At times, a user may wish to electronically post or view electronic content on an application or webpage. To do so, the user may be required to provide identification information and to be registered with the application or webpage prior to posting or viewing electronic content. There is currently no system or process that permits a user from being verified while maintaining their anonymity with the webpage or the application associated with electronic content.

### BRIEF DESCRIPTION OF DRAWINGS

FIGS. 1A-1G are diagrams of an example environment in which systems and/or methods described herein may be implemented;

FIG. 2 is a diagram of a network environment;

FIG. 3 is a diagram of an example computing device;

FIGS. 4A and 4B are flow diagrams of example communications to initiate a verification process;

FIG. 5 is a flow chart of an example process for sending biometric and identification information for verifying a user;

FIG. 6 is flow chart of an example process for requesting to post or view electronic content;

FIG. 7 is an example process for verifying information received from a user device;

FIG. 8 is an example process for verifying information after deleting electronic history;

FIG. 9 is an example system diagram;

FIG. 10 is an example database structure for storing hash information;

FIG. 11 is an example electronic form for entering information;

FIG. 12 is an example electronic form for requesting to post electronic content; and

FIG. 13 is an example electronic form for approval to post electronic content.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may allow for a user, using an electronic application implemented on a computing device (e.g., smartphone, laptop, etc.) to post or view electronic content on another electronic application without providing biometric and/or identity information to the other electronic application. In embodiments, the biometric and/or identity information may be stored on the electronic application and/or the user device rather than storing the biometric and/or identity information on a server or other computing device. In embodiments, biometric information may be facial, fingerprint, voice pattern, and/or any other type of information that is associated with a human function or body feature that can be electronically communicated. In embodiments, identity information may be any documentation (e.g., passport, driver license, etc.) generated by a governmental or non-governmental entity that identifies a person based on the person's name, gender, address, biometric, and/or any other information.

In embodiments, at a later time, when the user deletes any electronic information relating to the viewing and/or posting content associated with the other electronic application, the systems, devices, and/or methods described herein may allow the other electronic application to generate recommendations (based on the deleted electronic information) which are electronically communicated to the user device. Thus, without any stored electronic history (e.g. browser history) of past electronic communications associated with a particular website, the user device may receive recommendations for future electronic communications that are related to the deleted electronic history.

In embodiments, once the user's biometric and/or identity information is confirmed, the systems, devices, and/or methods described herein may generate various electronic communications that allow for the biometric and/or identity information stored on the user device to be electronically pinged for confirmation. In embodiments, the biometric and/or identity information may be encrypted (e.g., with public keys, private keys, hashes, codes, etc.) while stored on the user device to prevent other computing devices from accessing the biometric and/or identity information. In embodiments, the biometric and/or identity information, once sent either in encrypted or non-encrypted format, may be received by a system (e.g., a blockchain, one or more computing devices, cellular systems, wireless system, etc.). In embodiments, the user may then send the biometric and/or identity information to a verification server. In embodiments, the verification server may verify the biometric and/or identity information and send an electronic verification communication to the system.

Accordingly, by using the systems, methods, and/or processes described in the following figures, a user may be verified using a first electronic application and then electronically post and/or view electronic content on a second electronic application without the second electronic application electronically receiving the user's biometric and/or identity information. Furthermore, the user's biometric and/or identity information may be stored by the user device rather than on the system that verifies the biometric and/or identity information thereby allowing for the system to anonymously and continuously monitor and verify the user device-stored biometric and/or identity information. Instead, the hashes, associated with the biometric, identity, and/or other information, stored by the system (e.g., a blockchain) may be used to confirm that the user is a verified user. In embodiments, the hashes are stored on the user device (or a related electronic application) and the user device is then synchronized with a system (e.g., a blockchain). Accordingly, the user device hash becomes part of a chain of hashes, with each hash value generated with another hash value, that allow for the verified user's identity to be maintained anonymously. Since each hash (and an associated value, string, data, etc.) is based on user's biometric and identity information, no hash can be a duplicate of any other hash stored by the system. Accordingly, the systems, methods, and/or processes described in the following figures allow for verification of a user's biometric and identity information without the biometric and identity information from being electronically sent and stored by other computing devices.

Accordingly, the electronic application, via one or more electronic processes, may (1) obtain biometric and/or identity information on a user device about a user, (2) electronically generate a hash based on the biometric and/or identity information, (3) verify the biometric and/or identity information (4) generate an ID based on the verification of the biometric and/or identity information, (5) register the user and maintain a continuous electronic communication stream between the user device and the system and/or other computing devices to allow the system to monitor the validity of the biometric and/or identity information, (6) use the ID to electronically communicate with a second electronic application, to view and/or post electronic content, and/or conduct electronic transactions (e.g., using electronic tokens) that may require a biometric challenge to confirm the user's identification, (7) permit the user to delete electronic information associated with past electronic information and receive electronic communications that provide recommendations for future electronic communications based on the deleted electronic information, and (8) use one or more hashes, stored by a system (e.g., a blockchain) to maintain verification of the user without storing the biometric and/or identity information on a server or other system. Thus, the electronic application may be used to prevent fraudulent activity by making sure that a person using a particular user device is that person and not someone else. Furthermore, the electronic application may also prevent fraudulent activity via confirmation of a user's biometric and/or other identity information. In embodiments, the electronic application may obviate any requirements to provide username and/or passwords for one or more websites (e.g., photo-sharing application, social networking applications, etc.) that require a profile and/or identification information to access and use the website. Thus, the electronic application may reduce electronic communication transactions (and related memory usage and data usage) by reducing electronic communications associated with verifications.

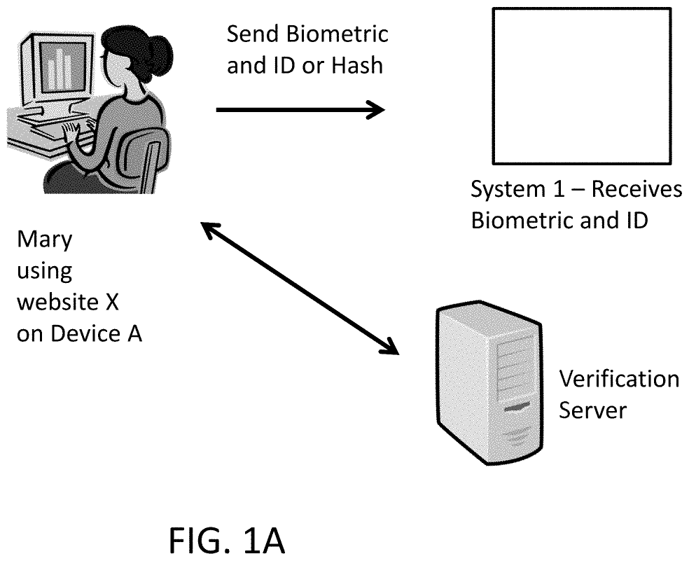

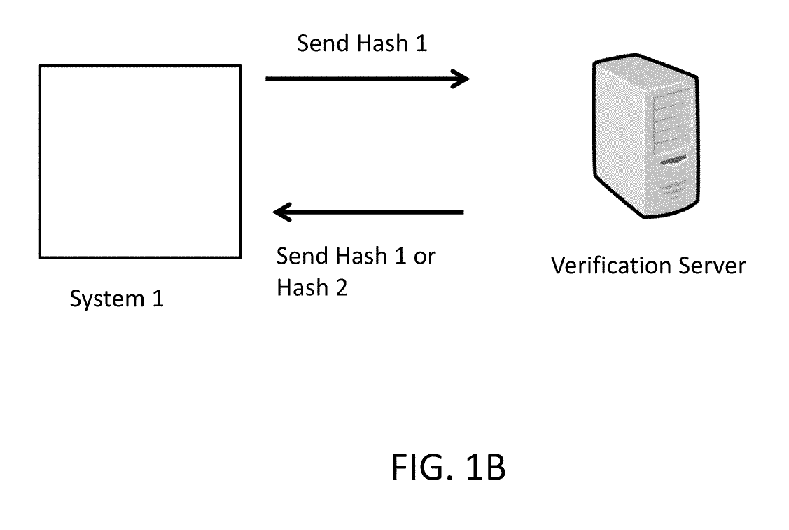

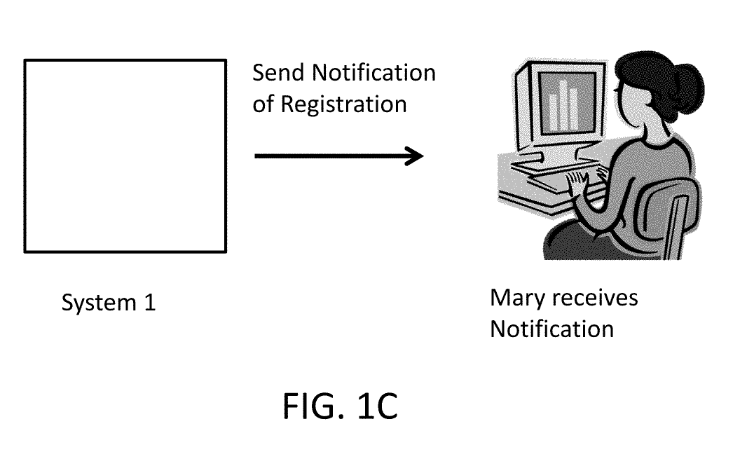

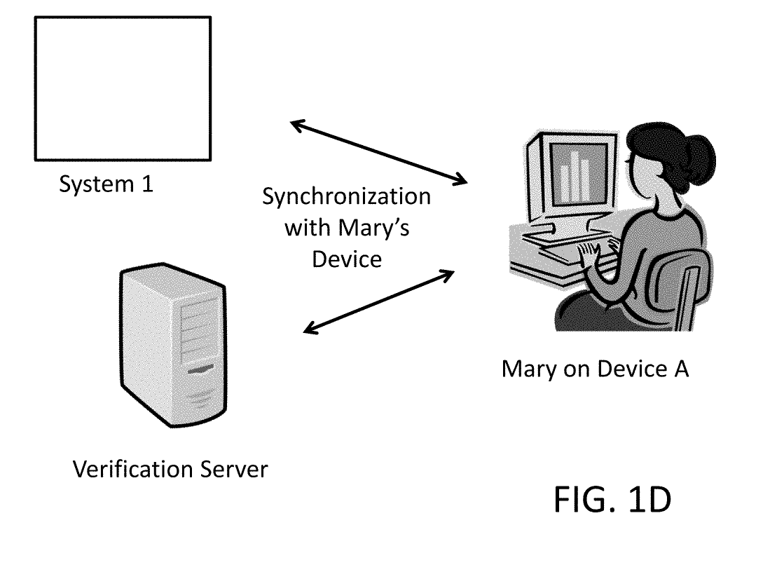

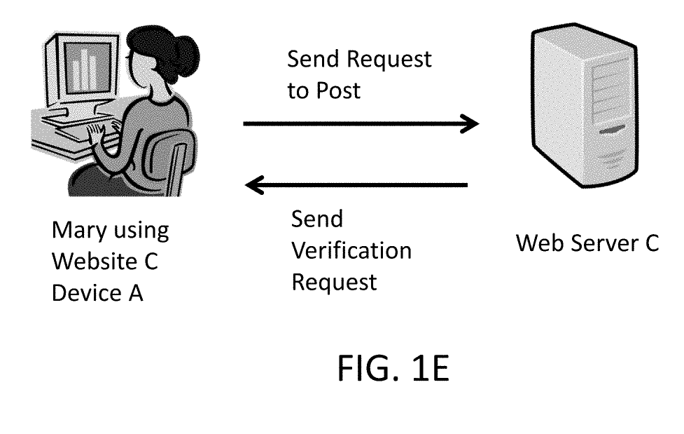

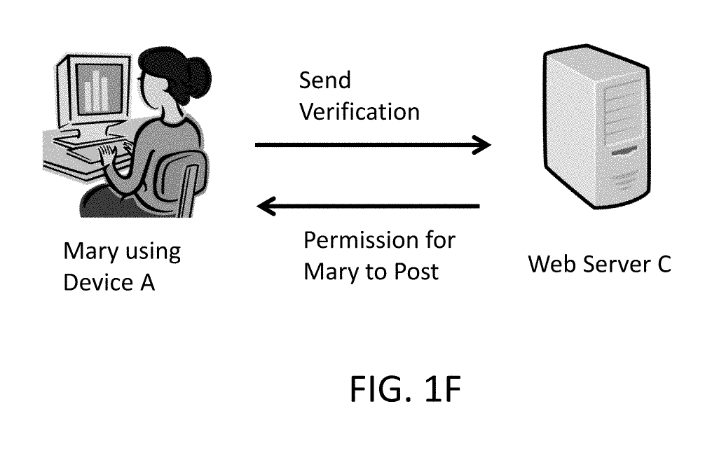

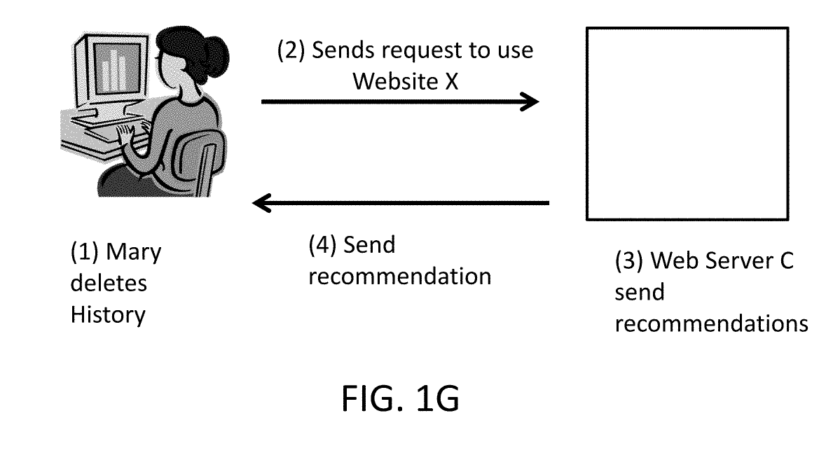

FIGS. 1A-1G describe one or more example processes for verifying a person's identity, continuing to maintain verification of the person's identity, and posting and/or viewing electronic content based on the verification of the person's identity. In this non-limiting example, Mary is using device A to access Website X. In embodiments, Website X may be a video streaming website, a social networking website, an online commerce website, and/or any other type of website or mobile application that has electronic content. While shown as desktop device, device A may be a smartphone, a laptop, a cellphone, and/or any other type of computing device. In embodiments, Device A may be a smartphone, laptop, computing device, etc. In embodiments, Website X may be a webpage, an electronic application, or other electronic interface that permits a user to provide electronic information via Device A. As shown in FIG. 1A, via device A, the user enters her biometric and identity (“ID”) information into Website X. In embodiments, Website X may allow Mary to scan a biometric feature (e.g., Mary's face, fingerprint, etc.) and also allow Mary to scan identity information (e.g., documents that show information about the person, such as name, age, date of birth, gender, home address, etc.). In embodiments, a hash (or digital code, digital fingerprint, and/or other process) may encrypt the biometric and ID information. In embodiments, the hash may be generated by Website X. As shown in FIG. 1A, hash is shown in Hash 1. Alternatively, the biometric and ID information may be sent via an application programming interface (API) to System 1 and the API may generate a hash of the biometric and ID information. While Hash 1 is shown as one hash, in other examples, multiple hashes may be generated for different types of information (e.g., one hash for biometric information, one hash for ID information, one hash for age information, one hash for gender information, etc.). As shown in FIG. 1A, System 1 receives Hash 1.

Also, as shown in FIG. 1A, Mary's biometric and ID information is shared with Verification Server. In embodiments, upon the input of information into Website X (or a related smartphone application), a virtual private network, or other process, may allow a computing device associated with Verification Server to view the biometric and ID information on the user device without storing the biometric and ID information on Verification Server. Alternatively, the biometric and ID information may be sent to Verification Server and stored by Verification Server. At a later time, Verification Server may delete information associated with the biometric and ID information. In either embodiment, Verification Server may analyze the biometric and ID information and verify that the biometric and ID information is valid.

As shown in FIG. 1B, System 1 may send Hash 1 to Verification Server. In embodiments, Verification Server may receive Hash 1. In embodiments, if Verification Server verifies the biometric and ID information, Verification Server may communicate the hash back to System 1 without any changes to the hash. Thus, by not changing the hash, Verification Server indicates to System 1 that the biometric and ID information is valid. Accordingly, the non-changed hash value indicates a verified user in System 1 and, accordingly, allows for System 1 (and Verification Server) to store a hash of a verified user without having to store the biometric and ID information. Thus, the user is anonymously stored by System 1 as a verified user.

In embodiments, if Verification Server does not verify the biometric and ID information, Verification Server may change the hash (e.g., changing a value, data, or string associated with the hash) and return the changed hash, Hash 2, to System 1. Thus, the changed hash indicates that the user (in this example, Mary) is not verified. Accordingly, the changed hash value indicates a non-verified user in System 1 and, accordingly, allows for System 1 (and Verification Server) to store a user as non-verified without having to store the biometric and ID information. Thus, the user is anonymously stored by System 1 as a non-verified user.

Once Mary's identity has been verified, System land/or Verification Server, as shown in FIG. 1D, electronically synchronize with website X on Device A. In embodiments, the electronic synchronization allows System land/or Verification Server to, at a particular time period (e.g., every minute, every hour, every day, etc.), to electronically communicate with Device A, via pings, electronic messages, etc., and obtain updated information regarding the user's (in this case Mary's) biometric and ID information. Accordingly, if there are any changes to the biometric and ID information stored in Mary's device, System 1 and/or Verification Server may determine that the identification of the person is no longer valid. In embodiments, Verification Server may also generate a unique identifier for Mary that is stored by Verification Server that is electronically sent to Mary's user device.

Once Mary's identify has been verified, Mary decides that she wants to post video content on Web Server C. As shown in FIG. 1E, using device A and website C, an electronic request to post video content is sent to Web Server C. In embodiments, the request may include the unique identifier. Upon receiving the request to post video content, Web Server C may electronically send an electronic communication to Verification Server to confirm that the unique identifier. In this non-limiting example, Verification Server confirms the unique identifier and electronically communicates the confirmation to Web Server C.

In embodiments, with the unique identifier confirmed, Web Server C sends a verification request to Mary. In embodiments, upon receiving the verification request, Device A may initiate a biometric challenge that allows confirmation of Mary's identity. In this non-limiting example, Mary passes the biometric challenge. As shown in FIG. 1F, a verification is sent to Web Server C. Upon receiving the verification, Web Server C sends a permission communication message to Device A (displayed on webpage C) which permits Mary to electronically post video content and/or view other video content.

At a later time, as shown in FIG. 1G, Mary has deleted electronic history—the electronic information about past electronic communications and interactions with various webpages and electronic applications. Thus, if one was viewing a web browser on Mary's device (user A), that person would not see any information about the past interactions by Mary with various webpages and electronic applications. In this non-limiting example, Mary decides that she wishes to view and/or post video content. As shown in FIG. 1G, Mary sends a request to interact with Website C to Web Server C. In this non-limiting example, Mary may again be verified in the examples described in FIGS. 1E and 1F. In other non-limiting examples, Mary may be verified by other example methods of verification, such as providing a username and password. Upon being verified again, Mary may receive from Web Server C one or more recommendations for viewing and/or posting electronic video content based on previous electronic communication between Mary's user device and Website C. Thus, without any stored electronic history on the user device (or a related application associated with website X) of electronic communications and/or transactions, Mary may receive electronic information for recommendations based on stored information on Web Server C.

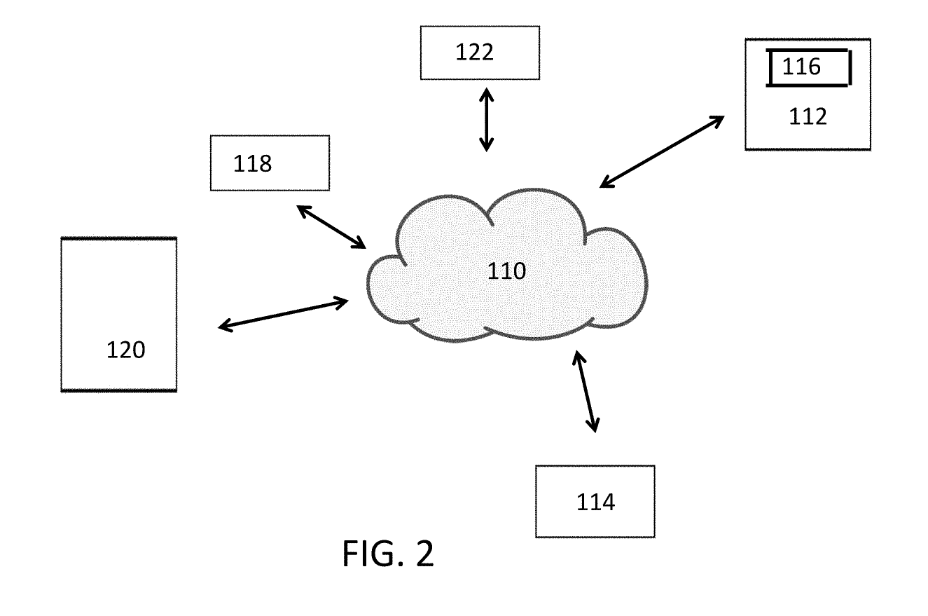

FIG. 2 is a diagram of example environment 100 in which systems, devices, and/or methods described herein may be implemented. FIG. 1 shows network 110, user device 112, user device 114, electronic application 116, web server 118, verification server 120, and System 122.

Network 110 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or alternatively, network 110 may include a cellular network, a public land mobile network (PLMN), a second generation (2G) network, a third generation (3G) network, a fourth generation (4G) network, a fifth generation (5G) network, and/or another network. In embodiments, network 110 may allow for devices describe any of the described figures to electronically communicate (e.g., using emails, electronic signals, URL links, web links, electronic bits, fiber optic signals, wireless signals, wired signals, etc.) with each other so as to send and receive various types of electronic communications.

User device 112 and/or 114 may include any computation or communications device that is capable of communicating with a network (e.g., network 110). For example, user device 112 and/or user device 114 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 112 and/or 114 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 112 and/or 114. User device 112 and/or 114 may have a touch screen and/or a keyboard that allows a user to electronically interact with an electronic application. In embodiments, a user may swipe, press, or touch user device 112 and/or 114 in such a manner that one or more electronic actions will be initiated by user device 112 and/or 114 via an electronic application.

User device 112 and/or 114 may include a variety of applications, such as, for example, a verification application, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.).

Electronic application 116 may be capable of interacting with user device 112, user device 114, web server 118, and/or verification server 120 to automatically and electronically analyze electronic information and determine whether to electronically verify information associated with one or more persons. In embodiments, electronic application 116 may obtain electronic information about a person's identity, such as biometric information (e.g., facial, fingerprint, audio, etc., of a person), name, address, age, citizenship, financial information, driver's license information, mortgage/rental information, and/or any other type of information associated with identifying a person. In embodiments, electronic application 116 may interact with application programming interfaces (APIs) to obtain electronic information from other electronic applications. In embodiments, electronic application 116 may be electronically configured to show photos, video, text, icons, graphical images, buttons, emojis, and/or any other electronic information. While FIG. 2 shows electronic application 116 on user device 112, electronic application 116 can also be stored on user device 114, and/or verification server 120.

Web server 118 may include one or computational or communication devices that gather, process, store, and/or provide information relating to one or more web pages or electronic pages that electronically display electronic content (e.g., advertisements, posts, messages, video content) associated with the one or more services.

Verification server 120 may include one or more computational or communication devices that gather, process, store, and/or provide information relating to one or more web pages or electronic pages associated with electronic application 116 that is searchable and viewable over network 110. While FIG. 2 shows a verification server 120 there may be additional verification servers 120 associated with one or more electronic applications 116. In embodiments, verification server 120 may verify a person's biometric and/or identity information. In embodiments, verification server 120 may have one or more APIs to perform electronic analysis and/or verification process and one or more database structures to store information about different types of documents, images, electronic communications, and/or other types of information. In embodiments, verification server 120 may be electronically controlled by an entity that is different (and/or independent) of another entity that controls web server 118; or, verification server 120 may be electronically controlled by the same entity that controls web server 118. In embodiments, one, some, or all of the verification and/monitoring processes of verification server 120 may be performed by web server 118.

System 122 may include one or more computational or communication devices that gather, process, store, and/or provide information relating to one or more electronic pages associated with electronic application 116. In embodiments, system 122 may include one or more computers that generate, or receive, a hash associated with biometric data and identity information associated with a user of user device 112 or 114. In embodiments, system 122 may generate an additional hash from the received hash and send one or more hashes to verification server 120. In embodiments, one or more hashes may be changed and/or deleted. In embodiments, system 122 may be a blockchain, a peer-to-peer network, or any other type of distributed network.

While FIG. 2 shows electronic application 116, there may be multiple different types of electronic applications 116 that each has their own server(s) that are similar to verification server 120.

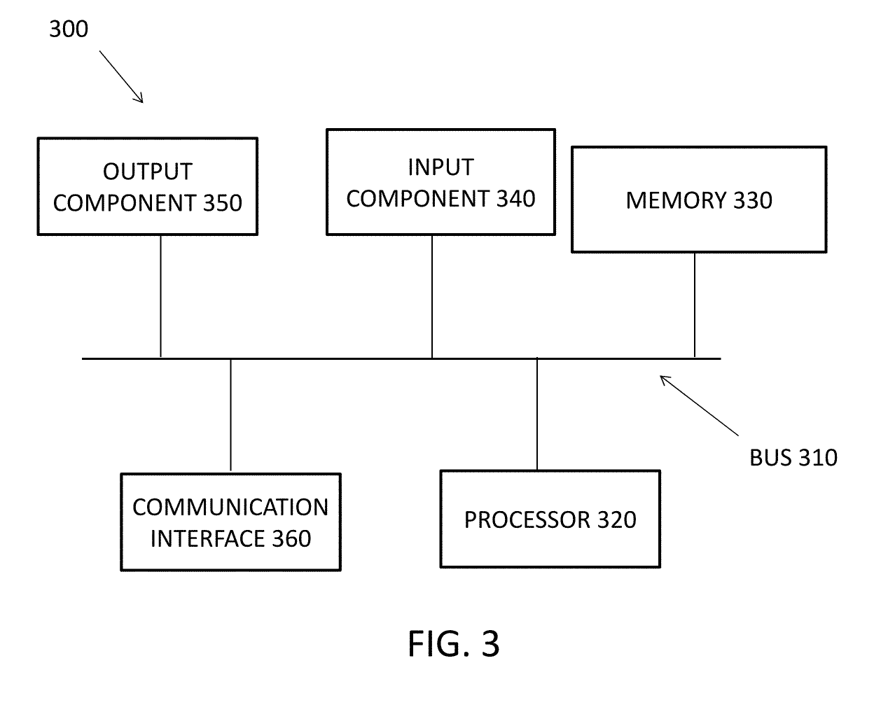

FIG. 3 is a diagram of example components of a device 300. Device 300 may correspond to user device 112, user device 114, web server 118, verification server 120, and system 122. Alternatively, or additionally, user device 112, user device 114, web server 118, verification server 120, and system 122 may include one or more devices 300 and/or one or more components of device 300.

As shown in FIG. 3, device 300 may include a bus 310, a processor 320, a memory 330, an input component 340, an output component 350, and a communications interface 360. In other implementations, device 300 may contain fewer components, additional components, different components, or differently arranged components than depicted in FIG. 3. Additionally, or alternatively, one or more components of device 300 may perform one or more tasks described as being performed by one or more other components of device 300.

Bus 310 may include a path that permits communications among the components of device 300. Processor 320 may include one or more processors, microprocessors, or processing logic (e.g., a field programmable gate array (FPGA) or an application specific integrated circuit (ASIC)) that interprets and executes instructions. Memory 330 may include any type of dynamic storage device that stores information and instructions, for execution by processor 320, and/or any type of non-volatile storage device that stores information for use by processor 320. Input component 340 may include a mechanism that permits a user to input information to device 300, such as a keyboard, a keypad, a button, a switch, voice command, etc. Output component 350 may include a mechanism that outputs information to the user, such as a display, a speaker, one or more light emitting diodes (LEDs), etc.

Communications interface 360 may include any transceiver-like mechanism that enables device 300 to communicate with other devices and/or systems. For example, communications interface 360 may include an Ethernet interface, an optical interface, a coaxial interface, a wireless interface, or the like.

In another implementation, communications interface 360 may include, for example, a transmitter that may convert baseband signals from processor 320 to radio frequency (RF) signals and/or a receiver that may convert RF signals to baseband signals. Alternatively, communications interface 360 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 360 may connect to an antenna assembly (not shown in FIG. 3) for transmission and/or reception of the RF signals. The antenna assembly may include one or more antennas to transmit and/or receive RF signals over the air. The antenna assembly may, for example, receive RF signals from communications interface 360 and transmit the RF signals over the air, and receive RF signals over the air and provide the RF signals to communications interface 360. In one implementation, for example, communications interface 360 may communicate with network 110.

As will be described in detail below, device 300 may perform certain operations. Device 300 may perform these operations in response to processor 320 executing software instructions (e.g., computer program(s)) contained in a computer-readable medium, such as memory 330, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

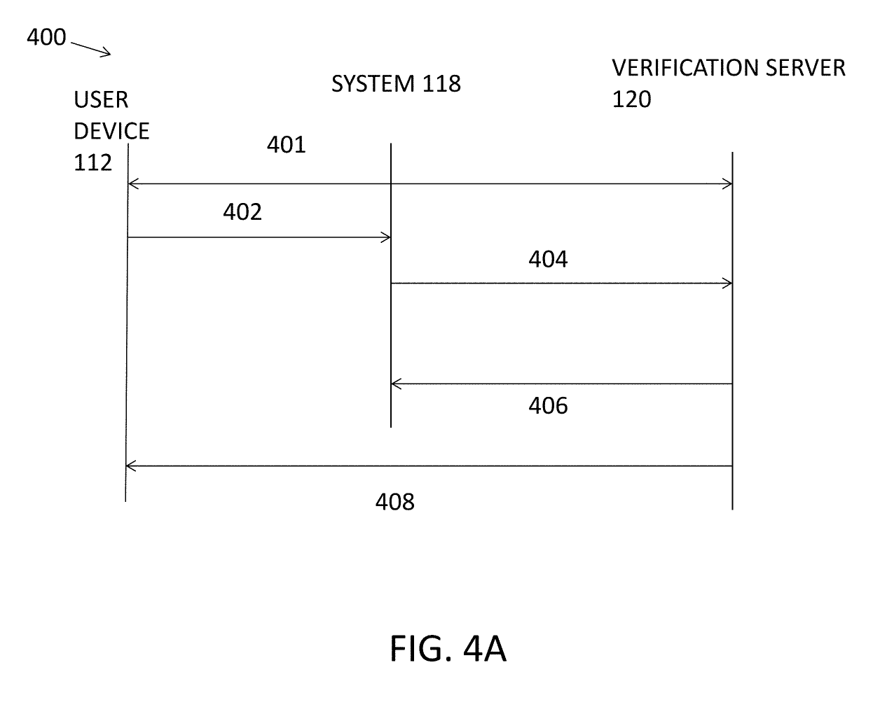

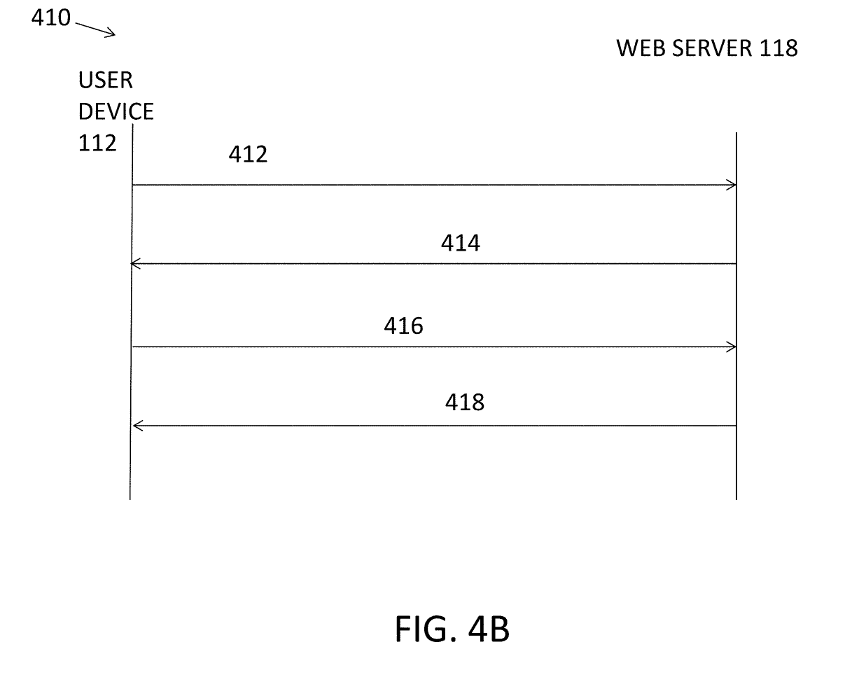

FIG. 4A describes an example communication flow process 400 for generating and verifying hashes. As shown, FIG. 4A includes user device 112, system 122, and verification server 120. In embodiments, as shown in FIG. 4A, user device 112 may electronically communicate with verification server 120 with electronic communication 401. In embodiments, verification server 120 may either (1) receive the biometric and/identity information, or (2) electronically view (via another computing device with a user interface) the biometric and identity information virtually (e.g., a VPN) without the biometric and identity information being sent to verification server 120. In embodiments, verification sever 120 may analyze the biometric and identity information and validate or not validate the biometric and identity information.

In embodiments, as shown in FIG. 4A, user device 112 may send electronic communication 402 which may include one or more hashes associated with the biometric and identity information sent in electronic communication 401 and associated with a user of user device 112. In embodiments, the one or more hashes may be associated with biometric information, document number information, age information, gender information, nationality information, and/or other information. In embodiments, user device 112 may (via an electronic application, such as electronic application 116) generate the one or more hashes. In alternate embodiments, user device 112 may send the biometric information and identity information to an intermediate device for generating hashes. In other embodiments, user device 112 may send the biometric and identity information in electronic communication 402 to system 122 and system 122 may generate the one or more hashes.

In embodiments, the verification server 120 may receive electric communication 404 from system 122. In embodiments, electronic communication 404 may include one or more hashes associated with a user that is being verified by verification server 120. In embodiments, verification server 120 may or may not verify the user's biometric and identity information. In embodiments, if verification server 120 verifies the biometric and identity information, electronic communication 406 may include the one or more hashes that were sent in electronic communication 404. In embodiments, if verification server 120 does not verify the biometric and identity information, verification server 120 may change a value, string, or data, associated with the one or more hashes and send an updated hash to system 122 in electronic communication 406. Thus, system 122 may store a hash that indicates a non-verified user. Alternatively, system 122 may receive the changed hash and delete the hash (and any other related hashes) from system 122. In embodiments, if the user's biometric and identity information is verified, verification server 120 may send, via electronic communication 408, a unique identifier to user device 112. In embodiments, if the user's biometric and identity information is not verified, verification server 120 may send, via electronic communication 408, an electronic denial message for display on user device 112 that the user of user device 112 is not verified. Thus, the electronic denial message in electronic communication 408 informs the user of user device 112 that the user has not been verified and the user cannot view of post electronic content on another website or electronic application.

FIG. 4B describes an example communication flow process 410 for posting and/or viewing electronic content. As shown, FIG. 4B includes user device 112 and web server 118. For the purposes of communication flow process 410, a user of user device 112 has been verified by system 122 and/or verification server 120 and the user is using user device 112 to electronically post and/or view electronic content. As shown in FIG. 4B, user device 112 may send electronic communication 412 which includes an electronic request to post and/or view electronic content on an electronic user interface associated with web server 118. In embodiments, electronic communication 412 may include a unique identifier that the user enters into an electronic page associated with web server 118. In embodiments, the unique identifier may be generated by verification server 120. In embodiments, web server 118 may receive electronic communication 412. In embodiments, web server 118 may send an electronic confirmation to verification server 120 regarding the unique identifier. In embodiments, if the unique identifier is confirmed by verification server 120, web server 118 may send electronic communication 414. If the unique identifier is not confirmed by verification server 120, web server 118 may send a denial message in electronic communication 414. In embodiments, if the unique identifier is verified, electronic communication 414 may include a verification request from user device 112. In embodiments, upon receiving electronic communication 414, user device 112 may generate an electronic biometric challenge or test that requires the user of user device 112 to provide biometric information. In embodiments, the biometric challenge may include a request for the user to provide their face, facial expression, fingerprint information, voice audio information, and/or iris information, via electronic application 116 on user device 112. In embodiments, the biometric information (for the challenge) is then analyzed by electronic application 116 and/or user device 112. In embodiments, the user's biometric information may be confirmed and user device 112 and/or electronic application 116 may send electronic communication 416 (which includes confirmation of the user's biometric information) to web server 118. In embodiments, web server 118 may receive electronic communication 416 which includes information that the user of user device 112 is confirmed. In embodiments, web server 118 may send electronic communication 418 that includes a message (displayable on user device 112's screen) that the user of user device 112 may view and/or post electronic content on electronic pages and/or electronic applications associated with web server 118.

In embodiments, the electronic communications shown in FIGS. 4A and 4B may be sent as a short message service (SMS), a multimedia message service (MMS), an email, a phone call, and/or any other type of electronic message. In embodiments, one or more of the electronic communications shown in FIGS. 4A and 4B may include electronic information associated with password, instructions, icons, and/or links (e.g., hyperlinks) that may be displayable on an electronic screen associated with user device 112 or any other computing device described in FIG. 2.

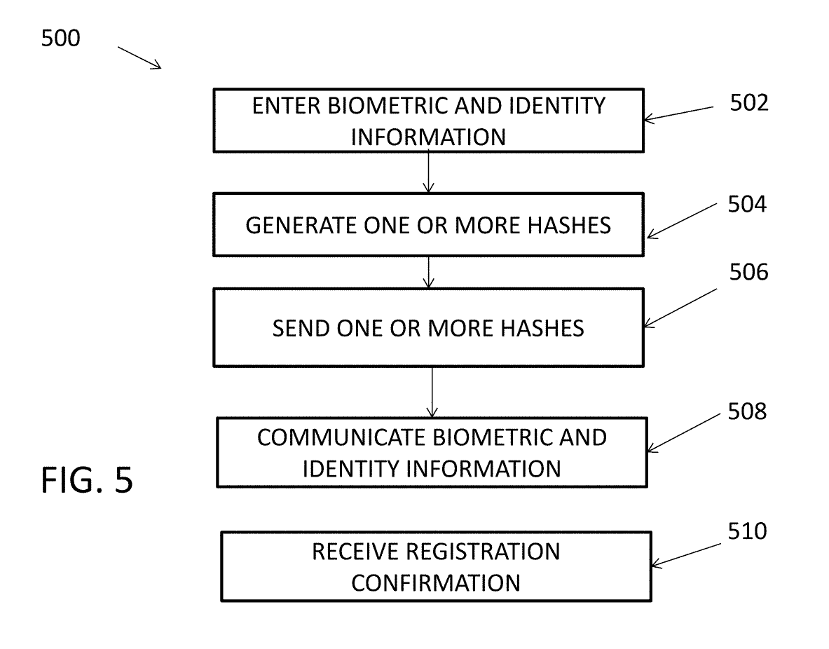

FIG. 5 is a flow chart of an example process 500 for verifying information. In embodiments, example process 500 may be performed by electronic application 116 and/or user device 112 by sending and/or receiving electronic information from other devices and/or systems, such as system 122 and/or verification server 120. At step 502, user device 112 and/or electronic application 116 receives biometric and identity information for a user of user device 112. In embodiments, the biometric information may be received by user device 112 and/or electronic application 116 based on interactions between the user and user device 112 and/or electronic application 116. In embodiments, a user may use facial, fingerprint, voice, or other biometric information that can be captured via a display screen of user device 112 and electronically analyzed by user device 112 and/or electronic application 116.

In embodiments, identity information may include government or non-government issued identification documentation, such as a passport, driver's license, worker permit, government ID card, or any other document that has a person's name, image, and/or any other identifying information. In embodiments, user device 112 and/or electronic application 116 may obtain identity information by user device 112 and/or electronic application 116 receiving electronic information inputted via an electronic form displayed on user device 112, via user device 112 electronically capturing information (e.g., image data) of the identity information, and/or other methods (e.g., voice input).

At step 504, user device 112 and/or electronic application 116 may generate one or more hashes based on the received biometric identity information, and additional information. In embodiments, the additional information may be associated with age information, gender information, document number (e.g., passport number, driver's license number, etc.), an identifier of user device 112, such as a mobile identification number (MIN), a mobile subscription identification number (MSIN), international mobile identity (IMI), international mobile equipment identity (IMEI), or an international mobile subscriber identity (IMSI) of user device 112. In embodiments, user device 112 and/or electronic application 116 may use another computing device (e.g., via an API) to generate the one or more hashes.

At step 506, user device 112 and/or electronic application 116 may send the hash to system 122. In embodiments, system 122 may store the hash which has a unique value, identifier, data, strings, etc., and/or other information. At step 508, user device 112 and/or electronic application 116 may communicate the biometric and identity information to verification server 120. In embodiments, verification server 120 (via a computing device with a user display interface) may virtually view the biometric and identity information (stored by user device 112 and/or electronic application 116) by using a virtual private network (VPN) or other process that does not require verification server 120 to electronically store the biometric and identity information. In embodiments, verification server 120 may verify the biometric and identity information by comparing the biometric and identity information with information stored by other computing devices and servers (e.g., government or non-government servers that include verified document and/or biometric information).

At step 510, user device 112 may receive an electronic communication indicating registration confirmation or non-confirmation from verification server 120. In embodiments, if verification server 120 has confirmed the user's biometric and identity information, the electronic message may include a unique identifier that may be used by the user of user device 112 and/or electronic application 116 to post and/or view electronic content on another application and/or website. In embodiments, with the user's biometric and identity information confirmed, the user may be able to conduct electronic transactions with electronic tokens or another electronic system associated with using electronic tokens to make purchases on a particular website. In embodiments, if verification server 120 has not confirmed the user's biometric and identity information, the electronic message may include a denial message that is displayed via user device 112 and/or electronic application 116.

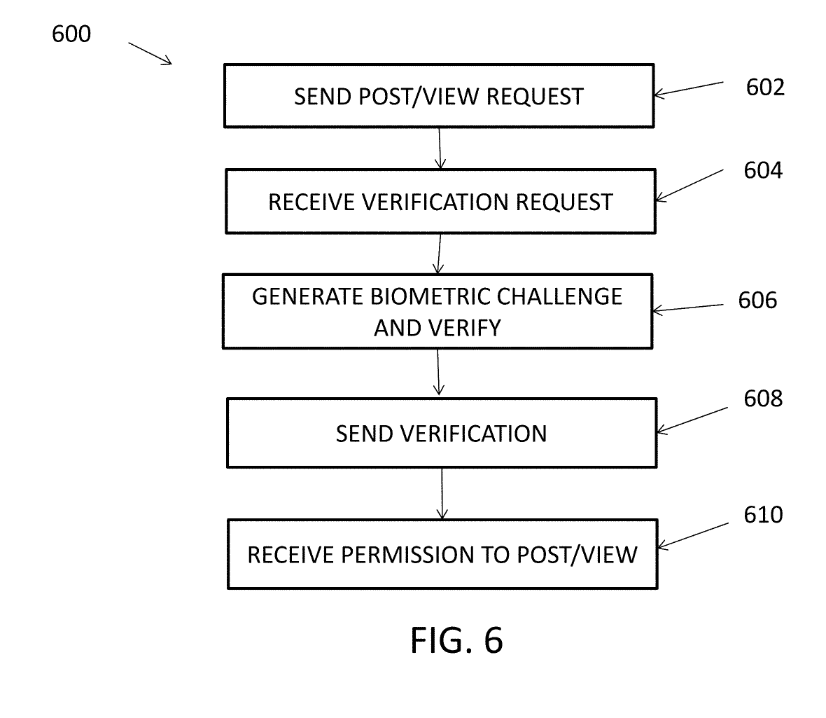

FIG. 6 is a flow chart of an example process 600 for posting and/or viewing electronic content. In embodiments, example process 600 may be performed by electronic application 116 and/or user device 112 based on sending or receiving electronic information from other computing devices, such as web server 118. At step 602, electronic application 116 and/or user device 112 may send an electronic communication that includes a request to view and/or post electronic content on a website or electronic application associated with web server 118. In embodiments, user device 112 may have a webpage or other type of electronic page displayed on user device 112 that includes one or more electronic selections that permit the user of user device 112 to enter a unique identifier (e.g., such as the unique identifier generated and described in FIG. 5). In alternate embodiments, electronic application 116 may include an electronic page that includes electronic features of the webpage associated with web server 118. Thus, a user of user device 112 may enter electronic information into electronic application 116 without having to use a dedicated webpage associated with web server 118. Thus, the user of user device 112 can use electronic application 116 to send and/or receive electronic communications between electronic application 116 and web server 118. In alternate embodiments, electronic application 116 may send a user's name, date of birth, gender, nationality, and/or other information.

Upon receiving the request to post and/or view electronic content, web server 118 may analyze the unique identifier and password and determine whether the unique identifier is valid. In embodiments, web server 118 may have received the unique identifier from verification server 120 or web server 118 may request verification of the unique identifier from verification server 120. In embodiments, web server 118 may analyze the unique identifier and password and determine that the unique identifier and the password are valid. Alternatively, web server 118 may determine that the unique identifier is not valid and may send an electronic message to user device 112 that the unique identifier and the password are not valid. However, if web server 118 determines that the unique identifier is valid, user device 112 and/or electronic application 116 may, at step 604, receive an electronic communication that includes a verification request. In embodiments, the verification request may include a request by web server 118 that the user of user device 112 to biometrically verify their identity. Thus, the user of user device 112 can be biometrically verified so as to prevent another individual from electronically entering the unique ID and/or password and gaining access to electronic content associated with web server 118.

In alternate embodiments, web server 118 may receive other information, such as user name, date of birth, gender, nationality, etc., instead of a unique identifier, from user device 112, and generate one or more hashes that are then sent to verification server 120 for comparison with the hash generated by user device 112 and sent to verification server 120 via system 122 as described in FIG. 5. Accordingly, if the hash sent from web server 118 matches the hash stored by verification server 120, then the user is verified and a verification electronic message is sent to user device 112 and/or electronic application 116 that the user is verified. Thus, user device 112 and/or electronic application 116 may include then conduct a verification request as described above with step 604. Alternatively, web server 118 may send an electronic confirmation to user device 112 and/or electronic application 116 and provide permission for the user to electronically post and/or view content on one or more pages associated with web server 118. Thus, steps 604, 606, and 608 are not required.

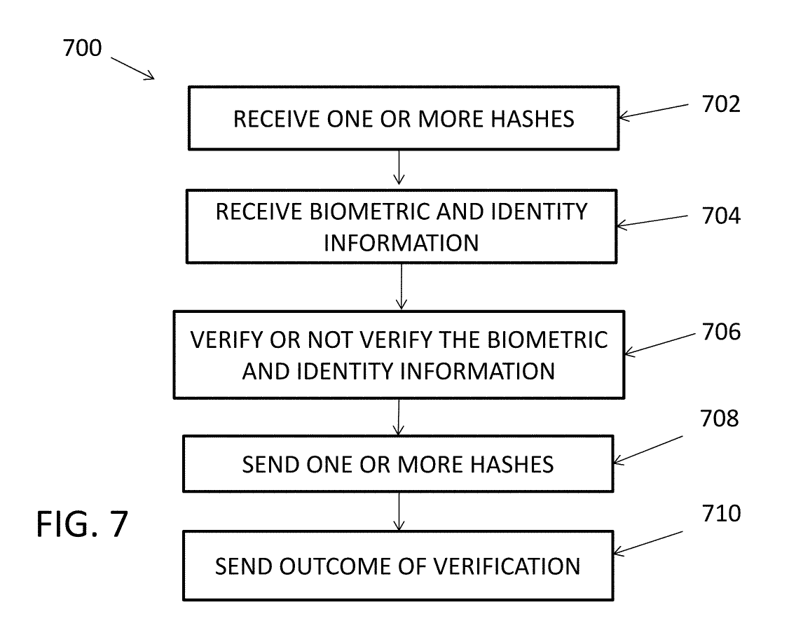

At step 606, user device 112 and/or electronic application 116 may generate a biometric challenge which includes requesting the user of user device 112 (who was verified in FIG. 5) to provide biometric information. In embodiments, the biometric challenge may include a request for the user to provide their facial image for display via user device 112 and/or electronic application 116, to enter fingerprint information via user device 112 enter eye (e.g., iris) information for scanning via user device 112 and/or electronic application 116, say a particular sentence (e.g., “please say ‘hello I'm happy today’”) particular words, or any words, via user device 112 and/or electronic application 116. In embodiments, user device 112 and/or electronic application 116 may verify the user of user device 112 as the user that is associated with the unique identifier and who was verified by system 122 (as described in FIGS. 5 and 7). In embodiments, if the user of user device 112 is not biometrically verified, then user device 112 and/or electronic application 116 may send an electronic communication to web server 118. Thus, web server 118 may deny the user of user device 112 the ability to electronically access to post and/or view electronic content on a webpage or electronic pages associated with web server 118.

However, if user device 112 and/or electronic application 116 verify the biometric information of the user of user device 112, then, at step 608, user device 112 and/or electronic application 116 may send an electronic communication to web server 118 that the user has been biometrically verified. At step 610, user device 112 and/or electronic application 116 may receive an electronic communication that provides permission for the user of user device 112 to electronically post and/or view electronic content on webpages and other types of electronic pages associated with web server 118.

FIG. 7 is a flow chart of an example process 700 for receiving and verifying information. In embodiments, example 700 may be performed by verification server 120 based on sending or receiving electronic information from and other computing devices, such as user device 112, electronic application 116, and system 122.

At step 702, verification server 120 may receive one or more hashes from system 122. In embodiments, the hash may be generated as described in FIG. 5. At step 704, verification server 120 may receive biometric and identity information associated with a user. In embodiments, verification server 120 may electronically view (e.g., via a computing device with a user interface) identifier information may be associated with a passport, driver's license, work permit, permanent residency card, etc. In embodiments, verification server 120 may electronically receive the biometric and identity information through a VPN or other type of virtual system that does not require verification server 120 to store the electronic information.

At step 706, verification server 120 may, or may not, verify the biometric and identity information. In embodiments, the verification may include verifying a document number (e.g., passport number, driver's license, permanent resident number, work permit number, etc.), the name on the document, gender, age, and/or any other information. In embodiments, any biometric information in the document (e.g., facial imagery, fingerprint image, etc.) may be verified by comparing biometric information to the identity information and or other information received from other computing devices that store verified information about the user. If the biometric and identity information is verified, at step 708, verification server 120 may send to system 122 the one or more hashes received from system 122 (in step 702) without any changes to values associated with the one or more hashes. Thus, the hash remains on system 122 and is considered to be associated with a verified user. In embodiments, as a result of the verification, user device 122 may synchronize with system 122. In embodiments, any changes to the biometric, identity, device identifier, and/or other information may result in a new hash generated by user device 122 and/or electronic application 116 which may result in a new verification process (as described in the previous figures) since any new hash will not match a previously generated hash based on different information.

Alternatively, if the biometric and identity information is not verified, at step 708, the one or more hashes received from system 122 (in step 702) have changes made to their values. In embodiments, the changed hash values are sent to system 122. Thus, the change in the value of the one or more hashes is an indication to system 122 that the user's biometric and identity information are not verified. In embodiments, the change in the hash may result in the deletion of the hash and/or additional information (e.g., related hashes) from system 122. At step 710, verification server 120 may send the outcome of the verification to user device 112 and/or electronic application 116. If the biometric and identity information is verified, verification server 120 may send a unique identifier that may be used by the user of user device 112 and/or electronic application 116 to electronically communicate with other electronic applications and websites. If the biometric and identity information is not verified, verification server 120 may send an electronic communication (displayable on an electronic display screen) to user device 112 and/or electronic application 116 that the biometric and identity information is not verifiable.

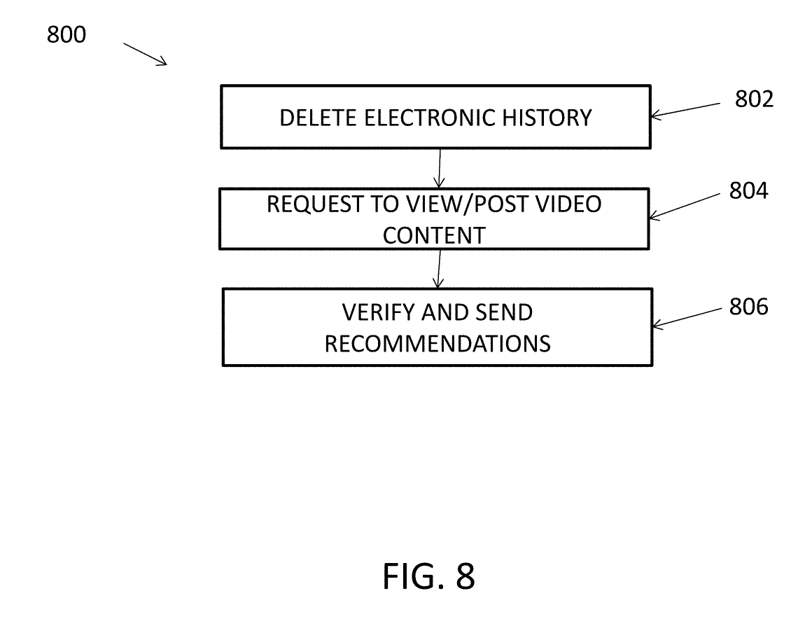

FIG. 8 is a flow chart of an example process 800 for receiving and verifying information after electronic history is deleted from user device 112 and/or electronic application 116. In embodiments, example 800 may be performed by user device 112 and/or electronic application based on sending or receiving electronic information from and other computing devices, such as system 122, verification server 120, and/or web server 118. At step 802, a user of user device 112 may submit one or more electronic commands, via user device 112 and/or electronic application 116 to electronically delete any information about prior electronic communications and/or transactions between user device 112 and/or electronic application 116 with electronic pages associated with web server 118. In embodiments, the deleted information may be browser history associated with an electronic web browser.

Accordingly, user device 112 and/or electronic application 116 may still have stored biometric and identifier information but no longer have the stored browser history associated with web server 118. At step 804, user device 112 and/or electronic application 116 may send a request to post and/or view electronic content associated with web server 118. In embodiments, user device 112 and/or electronic application 116 may send a unique identifier and be biometrically verified as described in FIG. 6. In alternate embodiments, user device 112 and/or electronic application 116 may send a username and/or password into a webpage associated with web server 118. In alternate embodiments, user device 112 and/or electronic application may not require the verification described in FIGS. 5 and 6 and may enter biometric and/or other types of information into the webpage. At step 806, user device 112 and/or electronic application 116 may verify the user's biometric and/or other types of information. Upon verifying the user's biometric or other types of information, user device 112 and/or electronic application 116 may send the verification to web server 118. Accordingly, user device 112 and/or electronic application 116 may then receive recommendations based on the user's past electronic communications with electronic pages associated with web server 118.

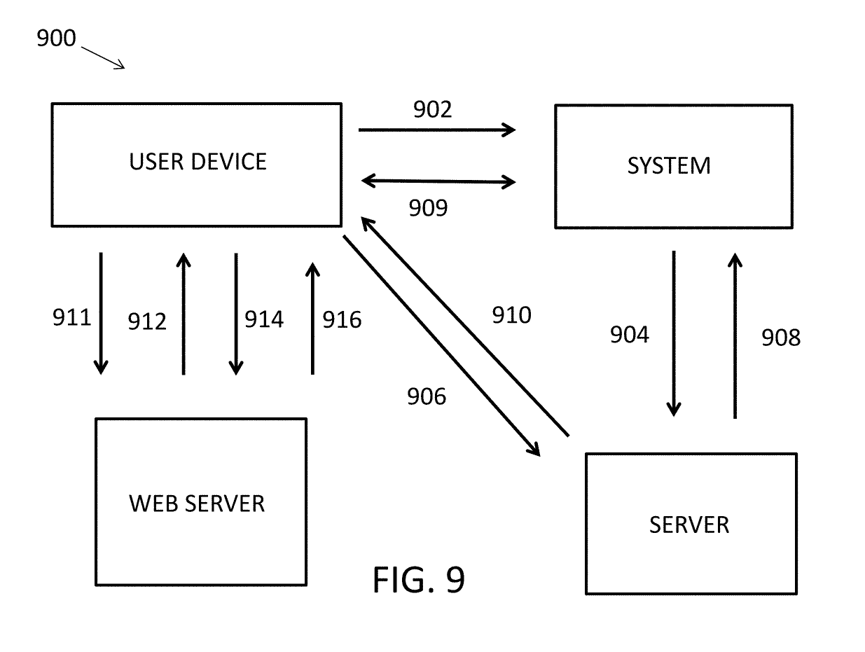

FIG. 9 describes an example system 900 that verifies a user's biometric and identity information and permits the user to electronically post and/or view electronic content. In embodiments, electronic communications are described as 902, 904, 906, 908, 910, 911, 912, and 914.

As shown in FIG. 9, User Device (e.g., user device 112) may send electronic communication 902 to System A. (e.g., system 122). In embodiments, electronic communication 902 may include either (1) a hash that includes biometric, identity, and/or mobile device identifier information, or (2) three separate hashes—one for biometric information, one for identifier information, and one for mobile device identifier information. In embodiments, User Device may generate the biometric, identity, and mobile device identifier information as described in FIG. 5. In embodiments, System A may receive the one or more hashes. In embodiments, System A may send one or more hashes to Server (e.g., verification server 120) in electronic communication 904.

In embodiments, Server may communicate with User Device (e.g., via a VPN) and obtain the biometric and identity information, via electronic communication 906. In embodiments, electronic communication 906 may be sent based on transmission of electronic communication 902. Alternatively, electronic communication 906 may be automatically sent by User Device to Server based on electronic pings (e.g., electronic communication 906) sent from an electronic browser extension that is part of a browser associated with an electronic application (e.g., electronic application 116). Alternatively, electronic communication 906 may be automatically sent by User Device to Server based on electronic pings (e.g., electronic communication 906) sent from Server to an electronic browser extension that is part of a browser associated with an electronic application on User Device. In embodiments, Server may verify the biometric and identity information. Upon verification of the biometric and identity information, Server may send electronic communication 908 to System A. In embodiments, electronic communication 908 may include the one or more hashes (received in electronic communication 904) unchanged. In embodiments, if the biometric and identity information is not verified, Server may change a value of one or more hashes and send the changed one or more hashes in electronic communication 908 to System A. In embodiments, System A may electronically synchronize, via electronic communications 909, with User Device, upon verification of the biometric and identity information, and electronically communicate with User Device or an associated electronic application (e.g., electronic application 116).

In embodiments, if the biometric and identity information is verified, System A may send a confirmation/registration message in electronic communication 910 to User Device. In embodiments, electronic communication 910 may include a unique identifier that a user of User Device can enter into one or more electronic pages associated with Web Server (e.g., web server 118). In embodiments, if the biometric and identity information is not verified, System A may send a denial message in electronic communication 910 to User Device.

As shown in FIG. 9, electronic communication 911 is sent from User Device to Web Server and includes a request to post and/or view electronic content associated with Web Server. In embodiments, electronic communication 911 may include a unique identifier (generated by Server) which is verified by Web Server with electronic communications with Server. In embodiments, Web Server may communicate with a browser extension that is associated with a website generated by Web Server and is electronically stored on User Device. In embodiments, Web Server may automatically ping the browser extension to verify the identity of the user of User Device to access content (or conduct other electronic transactions with a website associated with Web Server) without having to conduct electronic communication 912 and/or 914. In embodiments, Web Server may receive the request and send electronic communication 912 which includes a request for User Device to verify the user's biometric information (e.g., facial information, fingerprint information, voice information, iris information, etc.). In embodiments, upon receiving electronic communication 912, User Device may (e.g., using an electronic application such as electronic application 116) request the user to provide biometric information. In embodiments, if the user of User Device has been using the electronic application for a particular frequency level (e.g., every hour, every day, etc.), then the biometric information request may not be initiated. Upon verifying the biometric information, User Device may send electronic communication 914 to Web Server that indicates that the biometric information has been verified. Thus, as shown in FIG. 9, Web Server may send a message (electronic communication 916) to User Device that the user of User Device may post and/or view electronic content on one or more electronic pages associated with Web Server. Additionally, or alternatively, the user of User Device may also conduct electronic transactions via one or more electronic pages (e.g., webpages) associated with Web Server. For example, Web Server may provide the user the ability to purchase electronic content or products (e.g., both electronic and non-electronic) and may do so once verification of the user has occurred.

While not shown in FIG. 9, in alternate embodiments, when Web Server receives electronic communication 911, Web Server may generate a hash of user information (e.g., name, date of birth, etc.) based on receiving such user information in electronic communication 911 and send an electronic communication to Server. In embodiments, the electronic communication may include the hash which is then compared to the hash received by Server in electronic communication 904. In embodiments, if the hash is the same, then Web Server will receive another electronic communication from Server that the user information is verified. Accordingly, Web Server may then proceed with electronic communication 912 which then results in further electronic communications 914 and 916. Alternatively, Web Server may not require electronic communications 912 and 914 and proceed with electronic communication 916.

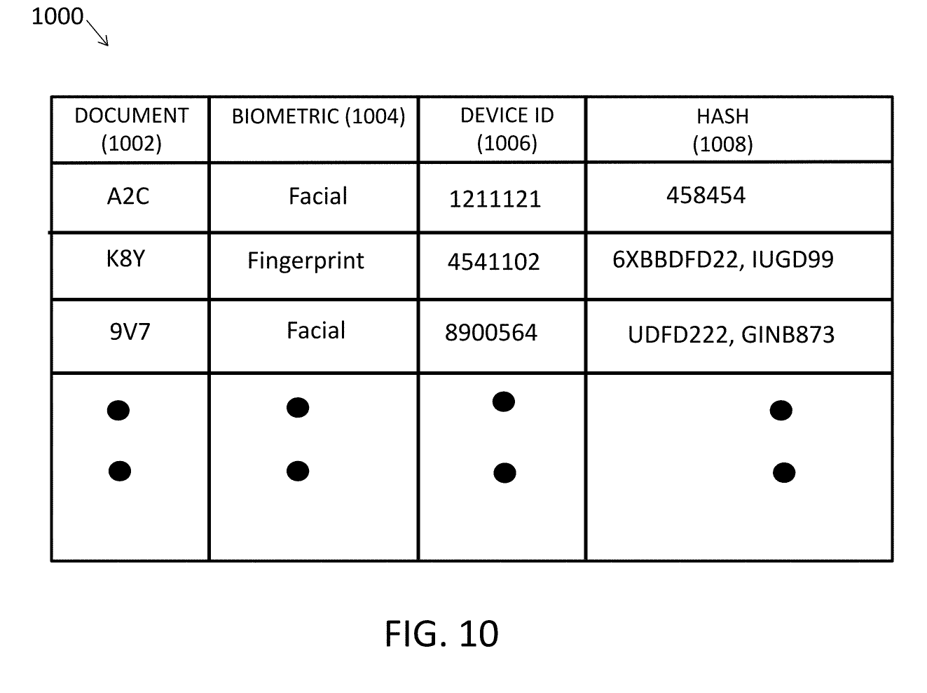

FIG. 10 describes an example data structure 1000 that stores biometric and identity information. In embodiments, data structure 1000 may include a collection of fields such as Document 1002, Biometric 1004, Device ID 1006, and Hash 1008. Although FIG. 10 shows example fields 1002-1008, in other embodiments, data structure 1000 may include fewer fields, different fields, additional fields, and/or differently arranged fields than depicted in FIG. 10. In embodiments, user device 112 and/or electronic application 116 may store some or all of data structure 1000. Additionally, or alternatively, verification server 120 and/or system 122 may store some or all of data structure 1000.

In embodiments, Document 1002 may store identifier information about a particular document for a user of user device 112. For example, in a non-limiting way, “A2C” may be for a driver's license, a passport, a work permit, and/or any other document that includes a person's biometric information (e.g., facial image, fingerprint information, etc.), address information, gender information, age information, and/or any other information that describes a person. In embodiments, Biometric 1004 may store biometric information about a user of user device 112. In embodiments, the biometric information in Biometric 1004 may be received via electronic application 116 by using a scanner, camera, or other device associated with user device 112. In embodiments, Device ID 1006 may store identifier information about user device 112. In embodiments, the user device identifier information may be a unique device ID (UDID), a mobile device ID (MID), an international mobile subscriber identity (IMSI) number, and/or any other unique identifier associated with user device 112.

In embodiments, Hash 1008 may be a generated encrypted value based on the information stored by Document 1002, Biometric 1004, and/or Device ID 1006. In embodiment, Hash 1008 may store one or more hashes associated with Document 1002, Biometric 1004, and/or Device ID 1006. For example, document A2C, biometric facial information, and device ID 1211121 are used to generate one hash—458454. Also, as shown in FIG. 10, document K8Y and fingerprint information are used to generate two hashes—6XBBDFD22 and IUGD99, one hash being for the document and the other hash being for the biometric information. Thus, different one or more hashes may be generated for one or more different types of information. In embodiments, each hash in Hash 1008 may be used by other systems (e.g., system 122) and/or devices (e.g., verification server 120) to generate additional hashes that are then used to confirm the identity of the user of user device 112. In embodiments, example data structure 1000 may include other types of hashes associated with other types of values. In embodiments, example data structure 1000 may include hashes for bank information, credit card information, and/or other types of information.

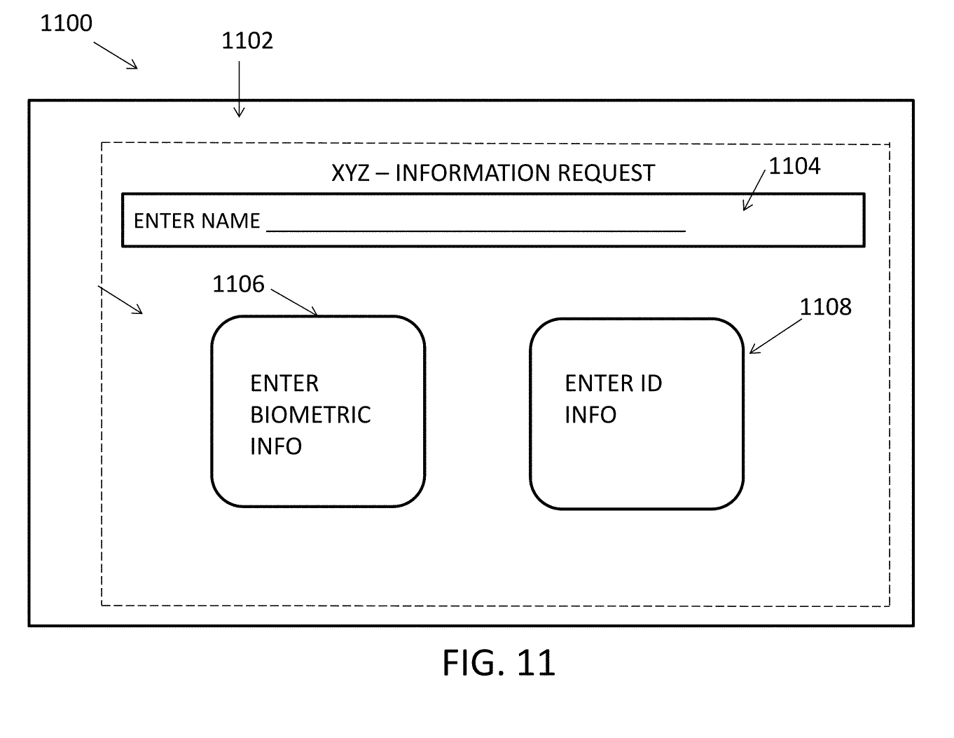

FIG. 11 shows an example electronic screen shot 1100 for entering information. In embodiments, electronic screen shot 1100 includes input screen area 1102, name input 1104, biometric input 1106, and ID input 1108. In embodiments, example electronic screen shot 1100 may be associated with an electronic screen associated with electronic application 116. In embodiments, name input 1104 allows for a user of user device 112 and/or electronic application 116 to electronically enter the user's name. In embodiments, biometric input 1106 may be an icon button or other electronic input that allows for a user to provide biometric information. In embodiments, selection of biometric input 1106 may initiate a camera, scanner, or any other device, associated with user device 112 and/or electronic application 116, to electronically receive biometric information for storage on user device 112 and/or electronic application 116. In embodiments, ID input 1108 may be an icon button or other electronic input that allows for a user to provide identifier information. In embodiments, selection of identifier input 1108 may initiate a camera, scanner, keyboard input, or any other device, associated with user device 112 and/or electronic application 116, to electronically receive identifier information for storage on user device 112 and/or electronic application 116.

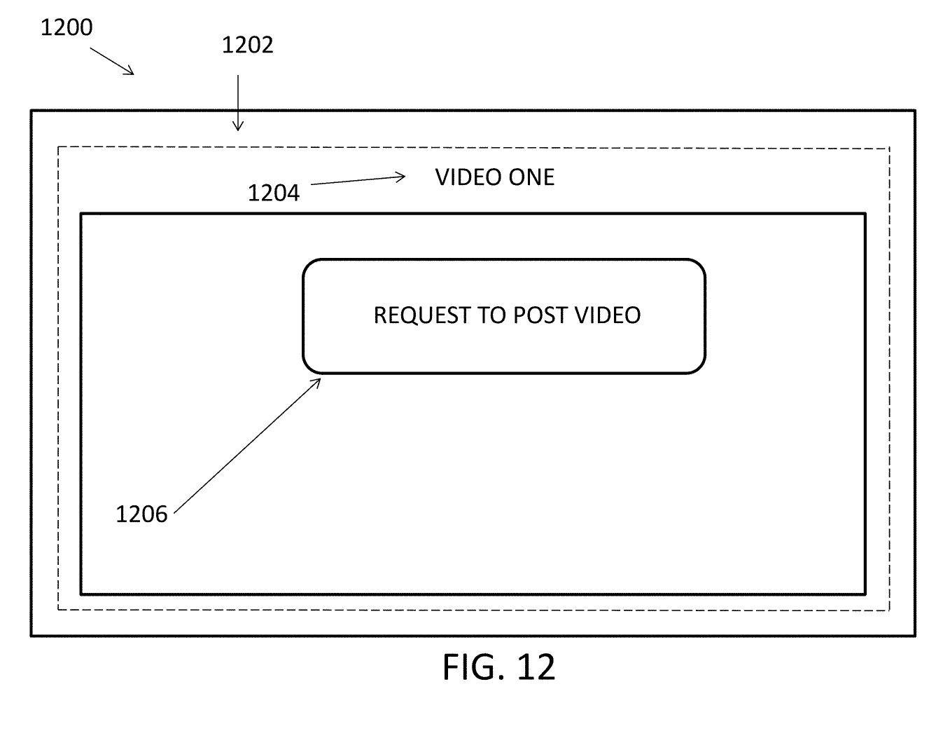

FIG. 12 shows an example electronic screen shot 1200 for requesting to post electronic content. In embodiments, electronic screen shot 1200 includes input screen area 1202, webpage title 1204, and request icon 1206. In embodiments, input screen area 1202 may be generated by a web server (e.g., web server 118) and displayed on an electronic page generated by the web server; or, input screen area 1102 may be generated by a web server and displayed on an electronic page generated by electronic application 116. In embodiments, webpage title 1204 may be the title/name of a website and/or electronic application associated with web server 118. In embodiments, request icon 1206 may an icon button or electronic input that allows for a user of user device 112 to send an electronic communication to a web server (e.g., web server 118). In embodiments, the web server may receive the electronic communication and initiate a verification process as described in FIG. 6.

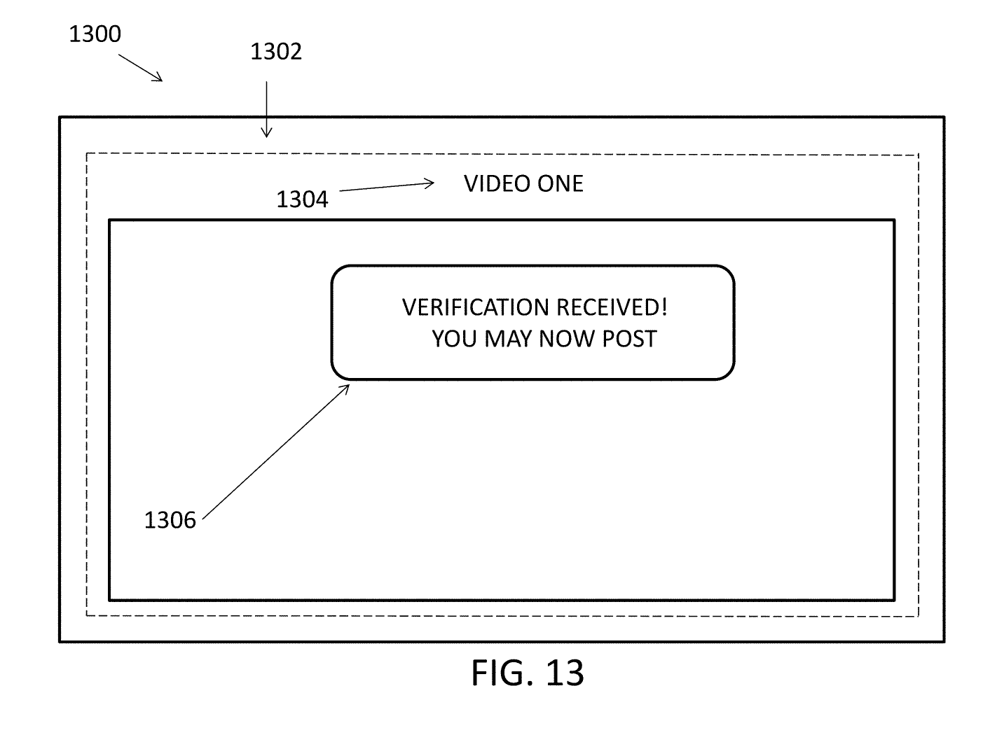

FIG. 13 shows an example electronic screen shot 1300 for confirming verification of a user so that the user may post and/or view electronic content. In embodiments, electronic screen shot 1300 includes input screen area 1302, webpage title 1304, and verification message 1306. In embodiments, verification message 1306 may be displayed on input screen area 1302 when a user's biometric information has been confirmed via a “biometric challenge,” as described in FIG. 6. In embodiments, electronic display screen 1300 may be displayed on user device 112 and also on electronic application 116 or an electronic page associated with web server 118.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 2, to complete such actions. Furthermore, it will be understood that these various actions can be performed by using a touch screen on a computing device (e.g., touching an icon, swiping a bar or icon), using a keyboard, a mouse, or any other process for electronically selecting an option displayed on a display screen to electronically communicate with other computing devices as described in FIG. 2. Also it will be understood that any of the various actions can result in any type of electronic information to be displayed in real-time and/or simultaneously on multiple user devices (e.g., similar to user device 124). For FIGS. 4, 5, 6, 7, and 8, the order of the blocks may be modified in other implementations. Further, non-dependent blocks may be performed in parallel. Also, it will be understood that any electronic post may include information about services and other information that may include user-generated and non-user generated text, numbers, photos, animation, multimedia content, and/or any other type of electronic content that can be analyzed for any of the reasons described in the above figures. It will be understood that an electronic post may be an advertisement, an electronic message, a text message, a SMS message, a MMS message, and/or any other electronic generated content (user and non-user) that can be electronically displayed on a user device screen. While the systems, methods, or processes described herein are in association with electronic content, the systems, methods, or processes described herein may be used to electronically (or non-electronically) post or view other types of content (e.g., audio content, textual content, images, etc.) and/or conduct (once verified) electronic transactions with electronic tokens (e.g., associated with a value that can be used to purchase electronic and/or non-electronic items). Further, once a user is verified (biometrically and/or via identity information) as described in the above figures, the user can also conduct electronic transactions with electronic tokens.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An electronic communications method, comprising:
receiving, by a device, biometric information;
generating, by the device, a hash associated with the biometric information;
sending, by the device, the biometric information to a first computing device;
sending, by the device, the hash to a second computing device;
receiving, by the device, verification of the biometric information based on sending the biometric information to the first computing device; and
synchronizing, by the device, an electronic application, stored by the device, with the second computing device based on receiving the verification of the biometric information.

2. The electronic communications method of claim 1, where the biometric information is associated with at least one of:
facial information,
fingerprint information,
audio information, and
iris information.

3. The electronic communications method of claim 1, further comprising:
sending a request to a third computing device to electronically view information on a third computing device.

4. The electronic communications method of claim 3, where the information on the third computing device is associated with electronic content.

5. The electronic communications method of claim 4, further comprising:
receiving, from the third computing device, a request to generate a biometric challenge;
conducting the biometric challenge;
receiving a result that the biometric challenge is passed; and
sending the results of the biometric challenge to the third computing device.

6. The electronic communications method of claim 5, where the biometric challenge includes providing the biometric information.

7. The electronic communications method of claim 6, further comprising:
receiving electronic content from the third computing device.

8. The electronic communications method of claim 1, where hash is used by the second computing device to generate an additional hash.

9. A device, comprising:
memory; and
a processor to:
receive biometric information;
generate a hash associated with the biometric information and an identifier associated with the device;
communicate the biometric information to a first computing device;
send the hash to a second computing device;
receive verification of the biometric information based on sending the biometric information to the first computing device; and
synchronize an electronic application, stored by the device, with the first computing device and the second computing device based on receiving the verification of the biometric information.

10. The device of claim 9, where the biometric information is communicated with the first computing device via a virtual private network (VPN).

11. The device of claim 10, where the biometric information is not stored by the first computing device.
